(19) United States
(12) Patent Application Publication
(10) Pub. No.: US 2011/0266395 A1
(43) Pub. Date: Nov. 3, 2011

(54) TETHER SHEATHS AND AERODYNAMIC TETHER ASSEMBLIES

(76) Inventor: JOEBEN BEVIRT, Santa Cruz, CA (US)

(21) Appl. No.: 13/048,693

(22) Filed: Mar. 15, 2011

Related U.S. Application Data
(60) Provisional application No. 61/314,084, filed on Mar. 15, 2010.

(51) Int. Cl. B64C 31/06

(52) U.S. Cl. 244/155 R

(57) ABSTRACT

The invention described herein relates generally to wind power generation. In particular, the invention relates to novel structures for tethers and tether operation. Also, methods and apparatus for power generation are described. The craft described herein are intended for electrical power generation utilizing the wind energy collected from air currents.

### CROSS-REFERENCE TO RELATED APPLICATIONS

This application claims priority to U.S. Provisional Patent Application No. 61/314,084 to Bevirt, filed Mar. 15, 2010, which is hereby incorporated by reference in its entirety.

### TECHNICAL FIELD

The invention described herein relates generally to wind power generation. In particular, the invention relates to novel structures for tethers, tether sheaths, and tether operation.

### BACKGROUND

The generation of electricity from conventional ground based devices has been under study for some time. However, such ground based electrical generation devices are somewhat hampered by the low power density and extreme variability of natural wind currents (in time and space) at low altitudes. For example, typical average power density at the ground is less than about 0.5 kilowatts per square meter (kW/m²). Higher altitudes offer more promising power densities.

Increased wind currents are commonly found a few hundred meters above the ground. Moreover, in the upper section of the Earth's boundary layer (at an altitude of about 1 kilometer), relatively stronger wind conditions can be obtained on a fairly consistent basis. Moreover, when very high altitudes are reached, the jet stream is encountered. This is advantageous because jet stream power densities can average about 10 kW/m². Thus, at higher altitudes wind generated power becomes an economically feasible alternative using existing technologies to generate power on an economically sustainable scale. The apparatuses and methods disclosed here present embodiments that can access high altitude wind currents and use the higher energy densities to produce power in some embodiments.

Issues discussed herein with regard to aerodynamic tethers, and other improvements, are not limited to kite systems. Systems involving airborne turbine driven power generation also benefit from the improvements discussed herein. Such airborne power generation systems may utilize cross wind flying technologies which result in the high speed motion of tethers. Accordingly, embodiments of the invention present solutions to some of the extent problems associated with existing wind powered electricity generation approaches.

### SUMMARY OF THE INVENTION

In one embodiment, the invention comprises a craft (kite, glider, etc.) tethered to a ground based energy generation device using an aerodynamic tether, which may be a tether with an aerodynamic sheath. The craft can comprise a “kite” configured with an airfoil and tethered to the ground based power generator. The craft and tether are configured to pull on the tether during a flight pattern calculated to pull on the tether that is connected to the generator to enable power generation. In some embodiments, an airborne power generation system may have an array of airfoils supporting wind turbine driven electrical generators. In some embodiments, the airborne system may engage in cross wind flying paths which may result in flight speeds significantly higher than wind speeds. In such systems, aerodynamic tether sheaths may significantly increase system performance and efficiency.

In some embodiments, the tether sheaths are manufactured using extrusion methods which may allow for manufacturing and cost efficiencies.

These and other aspects of the present invention are described in greater detail in the following detailed description of the drawings set forth hereinbelow.

### BRIEF DESCRIPTION OF THE DRAWINGS

The following detailed description will be more readily understood in conjunction with the accompanying drawings, in which:

FIGS. 1(a)-1(b) are simplified block diagrams illustrating aspects of wind energy power generation systems.

FIG. 2 is a view of a strutted flying power generation structure.

FIGS. 3(a)-3(k) are perspective and cross-section views of various embodiments of tethers constructed in accordance with the principles of the invention.

FIGS. 4(a)-4(b) are views of an aerodynamic tether in different wind orientations.

FIG. 5 is a sectional view of a tether with a stiffening element according to some embodiments of the present invention.

FIG. 6 is a sectional view of a tether with sheath according to some embodiments of the present invention.

FIG. 7 is a cross-sectional view of a tether with electrical conductors according to some embodiments of the present invention.

FIG. 8 is a cross-sectional view of a tether sheath according to some embodiments of the present invention.

FIG. 9 is a cross-sectional view of portions of a tether sheath according to some embodiments of the present invention.

FIG. 10 is a cross-sectional view of portions of a tether sheath according to some embodiments of the present invention.

FIG. 11 is a cross-sectional view of a tether sheath according to some embodiments of the present invention.

FIG. 12 is a cross-sectional view of a tether sheath according to some embodiments of the present invention.

FIG. 13 is an end view of a tether sheath according to some embodiments of the present invention.

FIG. 14 is an end view of a tether sheath according to some embodiments of the present invention.

FIG. 15 is an end view of a tether sheath according to some embodiments of the present invention.

FIG. 16 is a perspective view of a tether sheath according to some embodiments of the present invention.

FIG. 17 is a cross-sectional view of a tether sheath on a tether according to some embodiments of the present invention.

FIG. 18 is a side view of an airfoil according to some embodiments of the present invention.

FIG. 19 is an illustration of airfoil angles of attack and other aspects.

FIG. 20 is an illustration of two airfoil profiles according to some embodiments of the present invention.

FIG. 21 is a graph of the bending moments of airfoils discussed.

### DETAILED DESCRIPTION OF THE DRAWINGS

The present invention has been particularly shown and described with respect to certain embodiments and specific features thereof. The embodiments set forth herein below are to be taken as illustrative rather than limiting. It should be readily apparent to those of ordinary skill in the art that various changes and modifications in form and detail may be made without departing from the spirit and scope of the invention.

The following detailed description describes various approaches for putting aloft and recovering wind-energy harvesting devices. Such devices can be employed at many altitudes, but of particular utility when used to generate electrical power when positioned above the boundary layer (e.g., above an altitude of about 1 kilometer). Additionally, some embodiments can be used to exploit the high velocity winds present in the jet stream. Some of the embodiments described here make use of kites or gliders having airfoil lifting members. Such craft can also make use of launch and retrieval platforms including raised platforms that are elevated some distance above the ground.

Air currents a few hundred meters above the ground generally have increased wind velocities that can be well exploited by the craft of the present invention. Such wind velocities can range from the low 5 kph (kilometers per hour) winds to those of the jet stream. The jet stream includes a family of fast flowing, narrow air currents found in the atmosphere around 10 kilometers above the surface of the Earth. The wind velocity in the jet stream, although variable, is generally quite high. These jet streams present a vast untapped potential for wind generated energy.

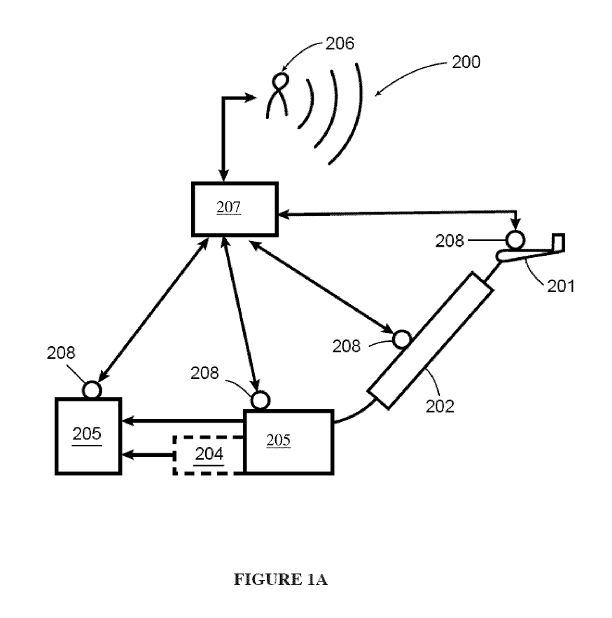

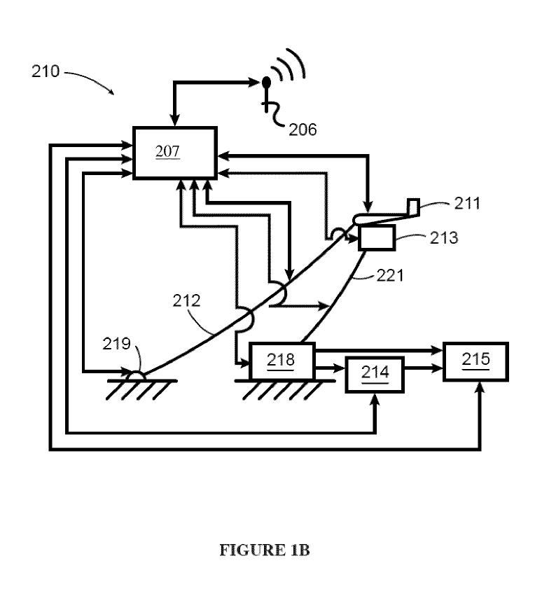

The inventor describes a number of energy generation approaches in this patent. FIG. 1(a) schematically represents an example system enabling energy generation in accordance with the principles of the invention. This system 200 described herein is not intended to be limiting, but rather provides a useful starting place to describe the many attributes of the disclosed invention. The system 200 includes a flyable aircraft 201 that is attached to an energy generation station 203 using a tether 202. Wind energy captured by the craft 201 is transferred to the energy generation station 203 using the tether 202. Generally, forces exerted by the tether 202 are harnessed and used to generate electricity at the generator 203. The system can further include an energy storage system 204 that forms part of the energy generation system 203. In alternative approaches, the energy storage system 204 can be separate from the energy generation system 203. Energy produced by the system 200 or stored 204 can be supplied to a distribution system 205 which can deliver the energy as needed. A typical example of such can be an electrical distribution network or power grid. Also, an atmospheric monitoring system 206 can be included to monitor weather, wind, and flight conditions. Such monitoring can include real-time information as well as forecasting information. The monitoring system can be ground-based, seaborne, airborne, or even space-based. Also, each of the disclosed systems 201, 202, 203, 204, 205, 206 can include sensor devices 208 that monitor the performance of each portion of the system 200 to provide information to a control system 207 that can adjust flight parameters and adapt to varying and changing conditions. This integrated system 200 can be used to among other things, optimize power generation, more efficiently distribute power, enhance system performance, adapt to variations in weather conditions, control the flight profiles of craft, adapt to system needs, local conditions, and a myriad of other performance and optimization information.

Another associated approach for harvesting wind energy applies to airborne wind turbine systems. FIG. 1(b) schematically depicts one such system. This system 210 described herein is not intended to be limiting, but rather provides a useful starting place to describe the many attributes of the disclosed invention. The system 210 includes a flyable aircraft 211 that includes an energy generation system 213 capable of generating electricity. This is commonly a turbine system 213 carried and kept aloft by the aircraft 211. The craft 211 is anchored to the ground 219 using a tether 212. Wind energy captured by the energy generation system 213 of craft 211 is transferred to a ground station 218 using an electrical transmission line 221. In one application the electrical transmission line 221 is supported by the tether 212. In another approach, energy generated can be transmitted to the ground station using an alternative carrier system (e.g., microwave generation and receiving stations). The system can further include an energy storage system 214. Energy produced by the system 210 or stored 214 can be supplied to a distribution system 215 which can deliver the energy as needed. A typical example of such can be an electrical distribution network or power grid. Also, an atmospheric monitoring system 206 can be included to monitor weather, wind, and flight conditions. Such monitoring can include real-time information as well as forecasting information. The monitoring system can be ground-based, seaborne, airborne, or even space-based. Also, each of the disclosed system elements 206, 211, 212, 213, 214, 215, 218, can include sensor devices S that monitor the performance of each portion of the system 210 to provide information to a control system 207 that can adjust power generation parameters and flight parameters and adapt to varying and changing conditions. This integrated system 210 can be used to among other things, optimize power generation, more efficiently distribute power, enhance system performance, adapt to variations in weather conditions, control the flight profiles of craft, adapt to system needs, local conditions, power generation concerns, and a myriad of other performance and optimization information.

In one approach a craft or “kite” 201 is attached to a long tether 202 and allowed to gain altitude. As the kite 201 gains altitude it applies forces on the tether. As the force applied by the kite continues, more and more of the tether 202 is played out. The tether can be attached to an energy generator 203 which generates electrical energy as a tether is played out. In a typical embodiment, the generator 203 includes a large reel of tether 202 which spins in one direction as the tether is played out under force generated by wind energy against the “kite” 201. In certain embodiments, the reel (part of the energy generator 203) forms part of an electro-magnetic power generator. During operation as the tether is played out, the reel spins enabling electrical power generation. Periodically, the kite can change its flight profile (e.g., angle of attack or other flight characteristics) to remove tension from the tether. When the tension is removed, the tether can be reeled in using relatively little energy. One method of reeling the kite in employs a small motor. Once the kite is reeled in a desired amount, the kite is maneuvered into a different flight profile enabling the wind generated force to again be applied to the kite. Various flight patterns can be used to effectively generate power. Examples include crosswind flight patterns such as “figure eight” patterns and so on. In any case the playing out and reeling in of the tether can be applied repeatedly for long periods of time enabling extensive power generation. The kites are generally flown at altitudes calculated to obtain the highest efficiencies for energy generation although any altitude can be selected. For example, the inventor contemplate that energy harvesting can be efficient at altitudes as lower as a few hundred meters with certain advantages also accruing at altitudes in the range of a few kilometers (e.g., 1-2 kilometers). However, the inventors expressly point out that the devices and systems disclosed herein are not to be confined to operation at any particular altitude. For example, the inventors specifically contemplate higher altitude operations an point out that certain advantages accrue when the kite is flown at jet stream altitudes. The power generation attributes of these craft can be enhanced by adding ancillary energy generation mechanisms such large solar panels to the craft and/or tethering systems. Also, auxiliary wind turbines can be mounted at various locations on the craft.

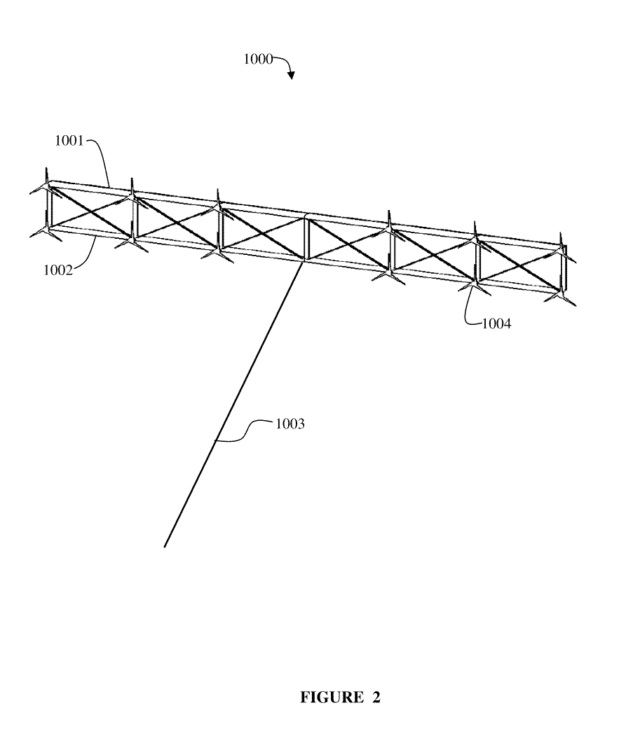

In some embodiments of the present invention, as seen in FIG. 2, an airborne power generation system 1000 may have two rows of airfoils 1001, 1002. The system may be adapted to use a tether 1003 with a nominal length of 1000 m. The system may utilize 12 turbine driven generators 1004 which are mounted along the two rows of airfoils. The turbines (propellers) may have a diameter of 2.4 m. The nominal total power rating of such a system may be 1 MW. The system may be adapted for flying at 74 meters/second in an 8.5 meters/second ambient wind using a cross wind flight path such as a circular flight path.

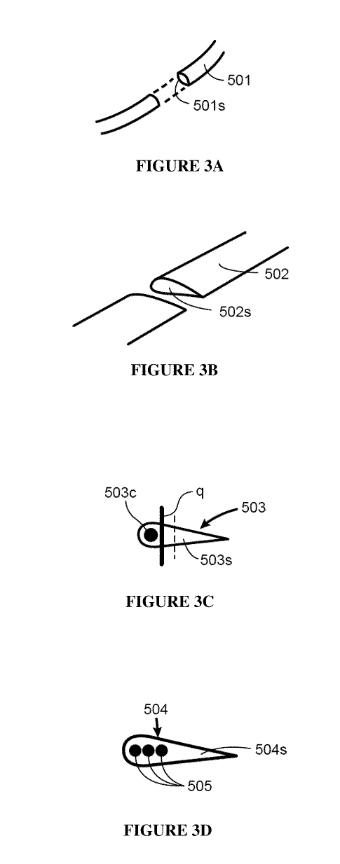

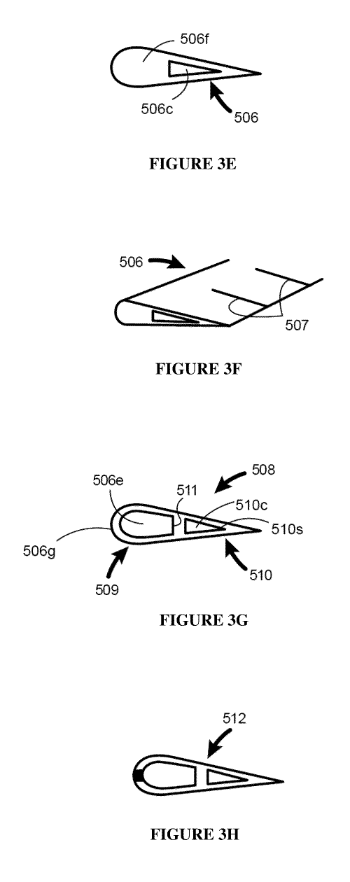

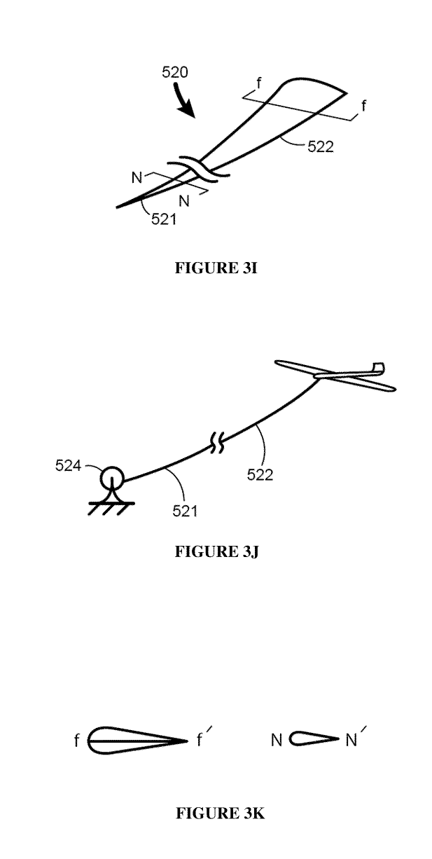

With reference to FIG. 3(a), the inventor has recognized that standard tethers 501 having a circular or cylindrical cross-section 501s exhibit poor aerodynamic performance characterized by high aerodynamic drag and poor stability. In order to address this problem, the tether can de designed with a reduced drag aerodynamic profile. In one embodiment FIG. 3(b) illustrated a tether having a low drag aerodynamic profile. The aerodynamic tether 502 has a cross-section 502s that is shaped like an airfoil. Moreover, the tether 502 is arranged so that the relative wind 503 is directed over the airfoil to generate a very stable tether that is not subject excessive flutter, vibration, and other aerodynamic instability characteristics.

With respect to FIG. 3(c) the inventors disclose a tether 503 having a cross-section 503s that is configured in airfoil shape. The tether 503 can be formed of a number of lightweight materials including, but not limited to, polyesters, LDPE, polyester foams and a variety of materials which may or may not be structurally reinforced by other materials used in strengthening members. Rugged coatings may also be applied. In this embodiment, a cable 503c is run through a channel in the tether 503. In some embodiments the cable 503c is moved forward of the quarter chord q of the airfoil 503. This cable position may be helpful in minimizing flutter and vibration in the tether.

FIG. 3(d) describes another tether embodiment in which a tether 504 having a cross-section 504s that is configured in airfoil shape. As before, the tether 503 can be formed of a number of lightweight materials which may or may not be structurally reinforced by other materials used in strengthening members. Rugged coatings may also be applied. In this embodiment, a plurality of cables 505 (shown here as three cables) are run through a complementary plurality of channels in the tether 503 (or even one large channel). In some embodiments the cables 505 are generally forward of the center of lift for the tether 504 or even forward of the quarter chord of the tether 504.

In another approach, the inventors have integrated the “cable” into the tether. With respect to FIG. 3(e) the inventors disclose a tether 506 having a cross-section that is configured in airfoil shape. The forward portion 506f of the tether 506 can be a solid material. For example, portion 506f can be a carbon fiber material or an extruded high strength carbon material as well as a range of other strong lightweight materials forming a structure that is very strong, giving remarkable structural strength to the tether 503. Other lightweight structurally strong materials can also be used. A rear or tail portion 506t can be formed with a rigid outer shell surrounding an inner chamber. The chamber can be gas filled (e.g., air) or be filled with a lightweight materials including, but not limited to, polyesters, LDPE, polyester foams and the like. As with other embodiments, rugged coating may also be applied.

FIG. 3(f) shows another embodiment of a tether 506. In this embodiment, the tether includes a number of stress and strain relief features 507 spaced along its length. This with enable various portions of the tether to move (e.g., twist, turn, stretch, expand, vibrate, compress, so on) at various points along its length to enable the tether to accommodate a wide range of stresses over its very long length.

In yet another approach, the inventors have another integrated tether. With respect to FIG. 3(g) the inventors disclose a tether 508 having a cross-section that is configured in airfoil shape. The forward portion 509 of the tether 508 can be formed with a rigid outer shell 509s surrounding an inner chamber 509c. For example, the rigid outer shell 509s can be constructed of a number of materials that have, among other characteristics, high strength to weight characteristics. Suitable materials include, but are not limited to, aramids, para-aramids, carbon fiber materials, UHMWPE's (ultra high molecular weight polyethylene materials). Such materials can include materials like Spectra®, Twaron®, GoldFlex®, Zylon®, Dyneema®, Kevlar®, a carbon fiber materials, extruded high strength carbon materials, multi-layer laminate materials, as well as a range of other strong lightweight materials forming a structure that is very strong, giving remarkable structural strength to the tether 508. Other lightweight structurally strong materials can also be used. A rear or tail portion 510 can be formed with a rigid outer shell 510s surrounding an inner chamber 510c. As with 509s, rigid outer shell 510s can be constructed of the same materials as the shell 509s. Typically, the structures can be integrated into a single outer shell having a center support 511 which can also be made of similar materials. The support 511 can run the entire length of the tether and can be supplemented with many other such supports. As with the prior embodiments, the chambers (509c, 510c) can be gas filled (e.g., air) or be filled with a lightweight materials including, but not limited to, polyesters, LDPE, polyester foams and the like. As with other embodiments, rugged coating may also be applied over the tether 508.

In yet another embodiment FIG. 3(h) depicts a tether 512 having another airfoil-shaped cross-section. In many ways the tether 512 is configured similarly to that of tether 508, i.e., a hard outer shell having inner chambers divided by at least one support. The forward portion of the tether 512 can be weighted 513 to shift the center of mass of the tether forward. This can increase stability and improve “flight” characteristics.

Other aspects of drag may come into play when using tethers in wind. These aspects may also be an important factor when utilizing cross-wind flying scenarios in which the speed of the kite, or the strutted flying structure, or other apparatus, is increased by flying not stationary in a steady wind condition, but instead by flying at increased speeds back and forth across the wind. These flying profiles may be circular, or other manners of flying.

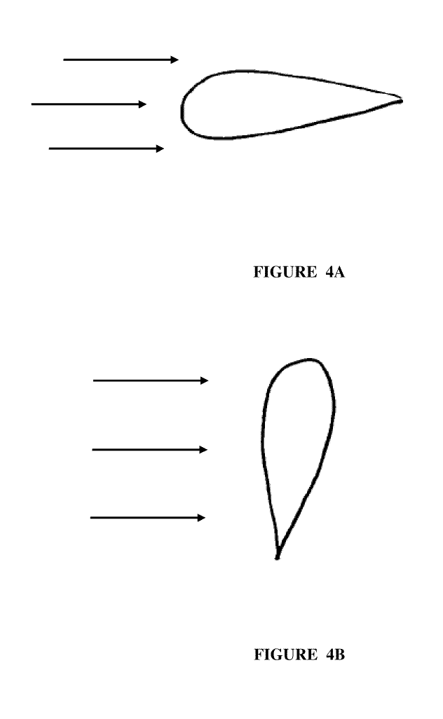

A concern may be that a tether with an airfoil shaped cross-section may tend to turn across the wind, wherein its “length” along the chord of the airfoil profile may twist and become a wider “width” with increased drag. The desired airfoil configuration with regard to the wind direction is seen in FIG. 4(a). The wind is seen coming into the leading edge of the airfoil shape. The wind direction may be the ambient wind direction in the case of a stationary kite or flying structure, or may be the airflow direction relative to a tether supporting a kite or flying structure engaged in a cross-wind flying regime such as a circular path. Cross-wind flying regimes may result in wind speeds much higher than the ambient wind speed, and the direction of the airflow relative to the tether may be a function of the kite motion as opposed to ambient wind direction, or a composite of both.

As seen in FIG. 4(b), the tether may “turn” relative to the wind. The drag of the tether in this case may be much higher than the drag in the case wherein the leading edge of the airfoil profile pierces the wind. Without proper design, the tether runs the risk of this being turned in the wind when having an aerodynamic profile. However, without an aerodynamic profile, such as in the case of a circular profile tether, the drag of the tether may be significantly higher, and may be in the region of an order of magnitude higher than tethers with an aerodynamic profile. In the case of a flying power generation system with multiple turbine driven generators, the drag of the tether using a cylindrical shape may be up to 40% of the total drag of the system, including the drag of the power generation. Also, this drag slows the flying system such that in cross-wind flying regimes the speed of flight, and the power generation therefrom, are both significantly reduced. The reduction of the drag of the tether allows for an increase in the cross-wind flying speed, and power generation may be significantly increased for the same airborne system mass.

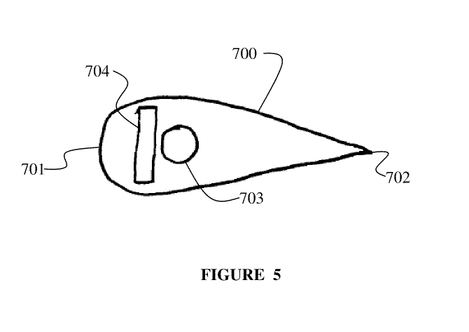

In some embodiments of the present invention, as seen in FIG. 5, a tether 700 with an aerodynamic profile is seen. The tether 700 has a leading edge 701 and a trailing edge 702. Within the tether body is a conductor portion 703. In some embodiments, the conductor portion 703 may have a coaxial conductor adapted for transmitting electrical power from an airborne power generation system. In some embodiments, there may be a structural element within the coaxial conductor, which may be between the inner and outer conductors. In some embodiments, the conductor portion 703 may be a parallel or twisted pair set adapted for transmitting electrical power from an airborne power generation system.

A stiffener 704 may be embedded in the tether 700 in some embodiments. The stiffener 704 may be of an asymmetric bending section such that the tether is not pre-disposed to bend in a cross-wise fashion to the wind, as may be the case if the tether gets “turned” into the wind. The stiffener 704 is adapted to bend, in a direction along the length of the tether, such that the tether maintains its aerodynamic profile in the wind. In some embodiments, the stiffener 704 may be of a rectangular cross-section. In some embodiments, a I beam or other profile may be used.

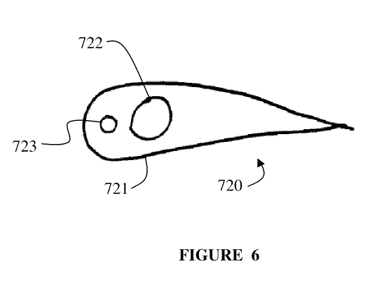

In some embodiments of the present invention, as seen in FIG. 6, an aerodynamic tether assembly 720 uses a sheath 721 which may surround a central portion 722. The central portion 722 may be a complete structural and electrically conducting portion in some embodiments. The central portion may have a coaxial conductor as well as a structural portion, such as Kevlar. The sheath 721 may be placed over the central portion 722 as an aerodynamic drag reducer. The sheath 721 may have the tether central portion placed within it, or in some embodiments the sheath may be adapted to surround the central portion and be fastened together, such as with Velcro or zipper type fastening. In some embodiments, the sheath may be attached in segments.

In some embodiments, a tether having a size change along its length. For example, as schematically depicted in FIGS. 3(i) & 3(j), a tether having a variable chord length is shown. The inventors point out that in some cases it may be advantageous to have a tether with a narrow chord at the portion 521 closest to the spool 524 and a substantially greater chord width at the portion 522 of the tether closest to the craft. FIG. 3(k) is a depiction of selected tether cross-sections taken near the ground (521) and further up the tether (522) providing one example to the different cambers. The relative ratios of the cambers can be designed in a manner that effectively balances aerodynamic properties, strength, weight considerations, and other relevant properties to yield an optimized tether for the craft chosen and local conditions.

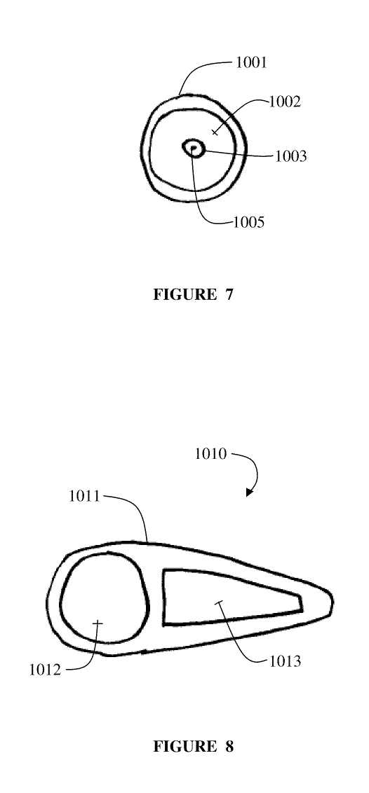

FIG. 7 illustrates a circular cross-sectional view of a cylindrical tether with both structural and electrical conduction aspects. The tether may have an outer case 1001, which may surround a structural element 1002 adapted to support the tensile loads associated with tethering an airborne flying system to a ground unit. An inner insulator 1003 may surround electrically conductive elements 1005. In some embodiments, the tether may be of coaxial type wherein a structural element, such as Kevlar, is in between the outer woven conductor and the center conductor. In embodiments of the present invention, the structural aspect with regard to the tensile load in the tether may be in the tether itself, as opposed to in the tether sheath. The tether and the tether sheath may be combined to form a tether assembly.

In some embodiments of the present invention, as seen in FIG. 8, a tether sheath 1010 is adapted to sheath a tether inserted into a tether hole 1012. The body 1011 of the tether sheath 1010 may of a plastic material in some aspects. A void 1013 may be used to reduce the mass and material usage of the tether sheath while allowing for the formation of an aerodynamic outer profile. The void 1013 may also be useful to provide flotation for the tether should it be desirable in systems flying over bodies of water.

In some embodiments, the tether sheath may be made of a material which can be extruded to form tethers of desired lengths, which may be very long lengths in some cases. In some cases, a series of shorter lengths of tether sheaths may be placed over the tether in sequence in order to achieve the effect of a long aerodynamic tether. In some embodiments, the tether sheath may have a coating on its outer surface. In some aspects, the coating may be adapted to protect the tether sheath from ultraviolet radiation or other atmospheric and/or environmental conditions.

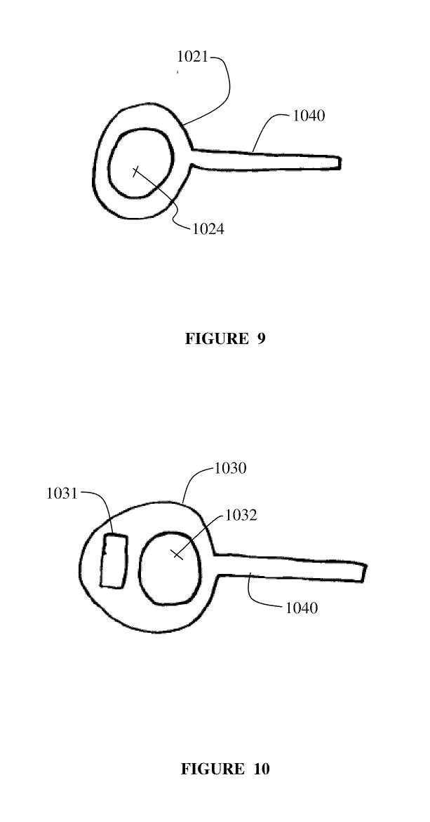

In some embodiments of the present invention, as seen in FIGS. 9 and 10, sheath bodies 1021, 1030 are adapted to form a main portion of a tether sheath which will sheath a tether. The tether sheath 1021 may be of a plastic or other material, and is adapted to have a tether in a tether hole 1024, 1032. A main rib 1040 is adapted to provide central support for the tether sheath, and may be used to provide stiffness while a lighter, softer material, such as a foam, is used to fill out the aerodynamic profile of the tether sheath. In some aspects, as seen in FIG. 10, the sheath body 1030 may include a mass 1031 which may enhance the performance of the tether assembly while flying in wind.

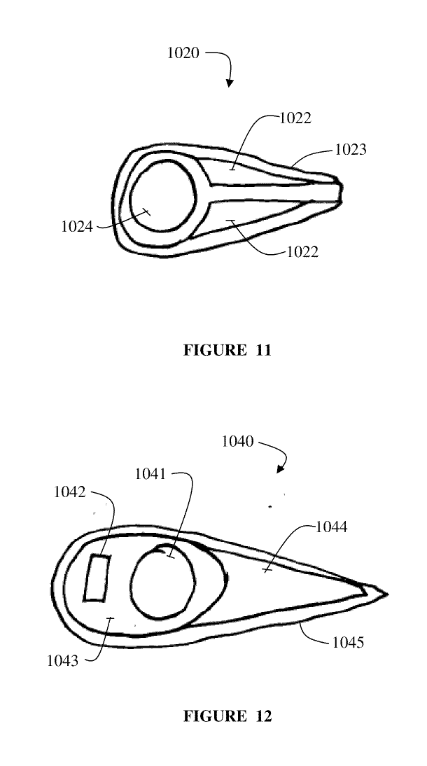

FIG. 11 illustrates a tether sheath 102 with a tether body 1021 that has been augmented with a second material, such as a foam along the sides 1022 of the tether body 1021. An outer layer 1023 may be used and may be bonded to the inner portions along the entire outer surface of the outer portions, or may be bonded only to the rear of the tether body in some aspects. The outer layer may be a cloth layer in some embodiments. The outer layer may be an aluminized mylar, or other thin layer.

In some embodiments, the tether is adapted to be manufactured using extrusion methods. In some cases, the tether body may be extruded. In some case, the tether body and the foam portions may be co-extruded in a single process, or in subsequent processes. In cases wherein a mass in embedded within the tether body, the mass may be drawn within the extrusion and co-extruded.

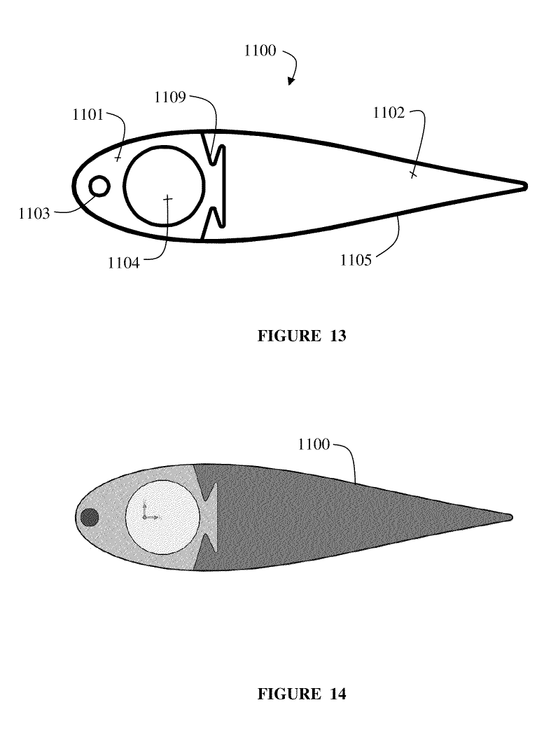

In some embodiments of the present invention, as seen in FIGS. 13 and 14, a tether sheath 1100 is adapted to provide aerodynamic drag reduction for a tether used with an airborne power generation system. The tether sheath 1100 may have a forward portion 1101 of a material such as PVC. A rear portion 1102 may be less stiff than the forward portion 1101 in some embodiments, and may be of a foam such as EPP or EPE. The forward portion 1101 may have a recess 1109 which may further secure the rear portion 1102 to the front portion 1101. A tether hole 1104 is adapted to receive a tether. In some embodiments, the tether sheath may have a mass portion 1103, which may be of brass in some embodiments. An outer layer 1105 may surround the inner materials in some embodiments. In some aspects, the outer layer may be a cloth such as nylon. In some aspects, the outer layer may be a UV resistive material.

In some embodiments, the tether hole may be placed along the chord length in a position between 5 and 25 percent of chord length. In some embodiments, the maximum thickness of the tether may be between 0.7 inches and 2.2 inches. In some embodiments, the chord length may be between 2.85 and 6.25 inches.

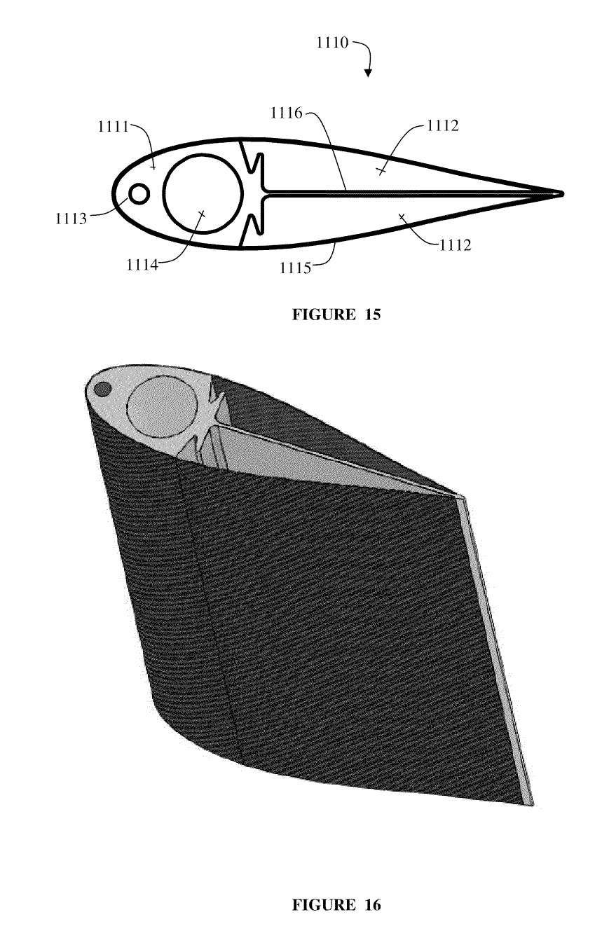

In some embodiments of the present invention, as seen in FIGS. 15 and 16, a tether sheath 1110 is adapted to provide aerodynamic drag reduction for a tether used with an airborne power generation system. The tether sheath 1110 may have a forward portion 1111 of a material such as PVC. The forward portion 1111 may include a rib 1116 of the same material. In some embodiments, the rib is formed in the same extrusion as the forward portion from the same material. Rear portions 1112 may be less stiff than the forward portion 1111 in some embodiments, and may be of a foam such as EPP or EPE. The forward portion 1111 may have a recess which may further secure the rear portions 1112 to the front portion 1111. A tether hole 1114 is adapted to receive a tether. In some embodiments, the tether sheath may have a mass portion 1113, which may be of brass in some embodiments. An outer layer 1115 may surround the inner portions in some embodiments.

FIG. 16 illustrates a partial perspective view of a tether sheath according to some embodiments of the present invention. The rear portions are omitted for clarity of viewing, although the space which they may take is seen. The forward portion, and the rib, which may be of plastic, with the mass portion in the fore of the forward portion (which may be of brass), may be extruded to form lengths of tether sheath. The rear portions, which may be of foam such as EPP, may be extruded onto the forward portion in a subsequent process, or alternately, the forward portion, mass portion, rib, and rear portions may all be co-extruded in a single continuous process. The outer layer, which may of fabric, may also be attached during this continuous process, or may be added during a subsequent step.

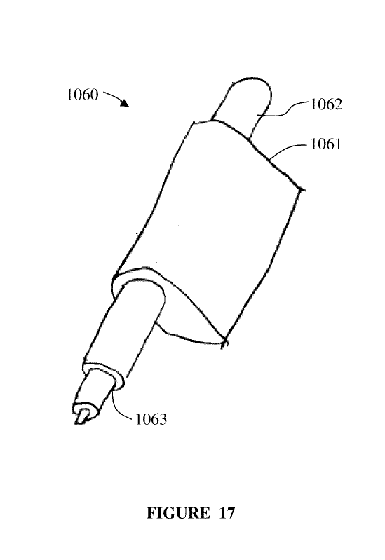

FIG. 17 illustrates a partial section of a tether assembly 1060 according to some embodiments of the present invention. The tether sheath 1061 is seen with a tether 1062 passing through it. A conductive element portion 1063 is seen within some tethers. In some embodiments of the present invention, the tether sheath is adapted to be used with systems whose tethers do not conduct electricity, such as the case of kite systems.

In some embodiments, a tether sheath may be used on the upper portion of the tether, whereas the lower portion of the tether nearer to the ground may be unsheathed.

A tether assembly wherein a tether sheath has been placed over a tether may significantly reduce the drag of a tether. For example, using a 0.4 inch diameter tether as an illustrative example, the tether may have a certain drag while experiencing apparent winds. Using as an example a wind direction perpendicular to the tether length axis, a 0.4 inch cylindrical tether may have a drag force in a 35 mph wind of 0.15 pounds per linear foot of tether. At 65 mph, this drag may increase to 0.46 pounds per linear foot. Using a tether with a 0.7 inch maximum thickness, a chord length of 2.85 inches, and with the tether centered at the 20% chord length position, the sheathed tether drag may be 0.034 pounds per linear foot at 35 mph, and 0.062 pounds per linear foot at 65 mph. The drag reduction may be in the range of 80-90%.

Another distinct advantage of the tether sheath is that in some embodiments, the tether sheath may be manufactured in relatively short lengths, and then have the longer tether inserted through it. For example, a tether may be 1000 meters long. There may be advantages to manufacturing the tether, with its structural aspect for tensile loading, and with its electrical conduction aspect, separately from the aerodynamic tether sheath. The tether sheath could thus be manufactured in shorter lengths, in the range of 3-15 meters, and be inserted over the tether after the prior manufacture of both the tether and the sheath.

Tethers and tether sheaths according to embodiments of this invention may be advantageous not only for reduced drag but also for their dynamic effects. For example, a tether sheath may allow for rotation around the tether in a manner which enhances the dynamic stability performance of the system. As discussed below, the pitching moment may be used as a factor in the dynamic performance of the tether assembly. Examples below illustrate the pitching moment in addition to the lowered drag discussed above. The airfoil shape selected for a particular application may be designed around flight speed regimes. The flight speed and the characteristic length of the airfoil, which are parameters related to the Reynolds number, are important parameters with regard to the design of the airfoil shape in some embodiments.

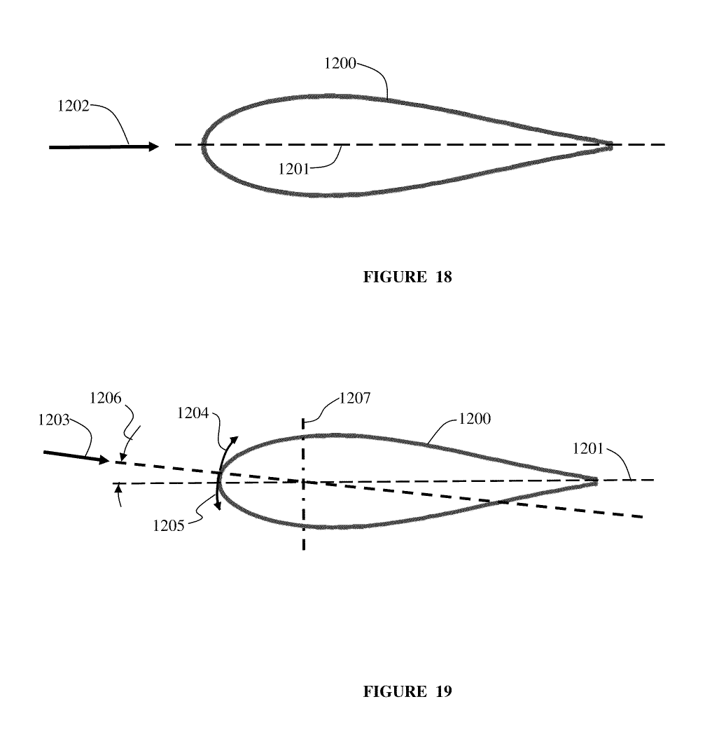

FIGS. 18 and 19 are used to illustrate parameters which may be considered for tether and tether sheath design. As seen in FIG. 18, the apparent wind direction 1202 is seen as hitting the symmetric airfoil 1200 along its centerline 1201. In such a case, the pitching moment of a symmetric airfoil is zero. The pitching moment is defined as the moment around the one quarter chord position of the airfoil. The pitching moment may be a function of alpha, the angle of attack of the airfoil. In the example of FIG. 18, the angle of attack alpha is zero.

FIG. 19 illustrates the airfoil 1200 with an angle of attack alpha 1206, wherein the centerline 1201 and the wind incidence direction 1203 are no longer coincident. Of notice with regard to some embodiments of this invention is the reaction of the airfoil 1200 when the wind is not centered, in other words when alpha is not zero. With a symmetric airfoil, the pitching moment is zero at zero alpha. As the angle of attack goes from zero to a non-zero value, in either direction, there may be a change of the value of the pitching moment. In many cases, once the angle of attack alpha has moved in one direction, the pitching moment will be in the direction of alpha, and tend to increase the angle of attack. Using airfoil 1200 as an example, with alpha seen as a clockwise value 1206, the pitching moment could be in the same direction 1204, or in the opposite direction 1205.

In the case of a tether and tether sheath wherein the tether is under tension, and is used to support an airborne power generation system, for example, there may be great advantage to having a negative pitching moment for a positive alpha. In other words, with the use of a flexible tether, which may be sensitive to dynamic aspects of the tether, it may be disadvantageous to have the tether, once off wind (alpha no longer zero), to be subject to force which furthers it off wind position.

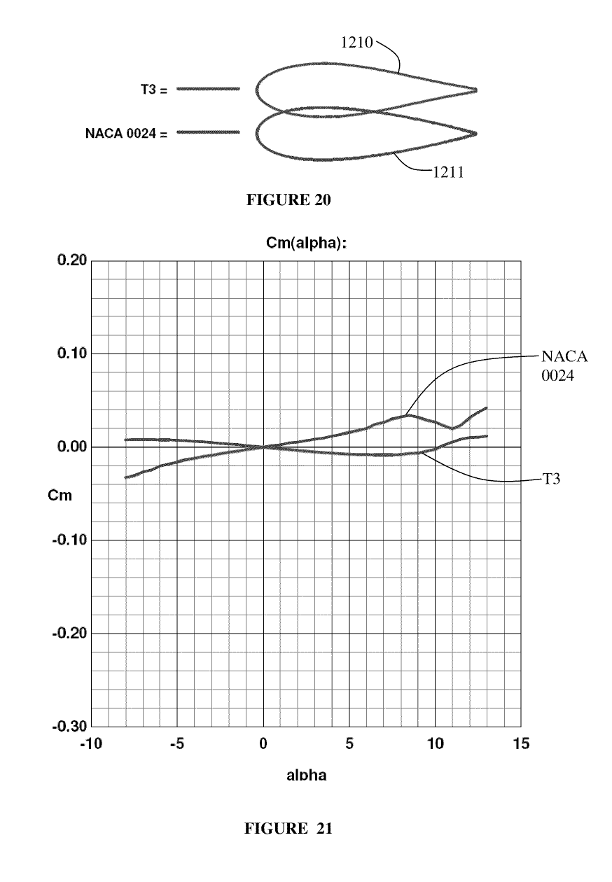

In some embodiments of the present invention, as seen in FIGS. 20 and 21, a symmetric airfoil shape used on an aerodynamic tether shield is adapted to have a negative pitching moment for a positive alpha. A comparison of two symmetric airfoils is seen in the graph. Both are symmetric airfoils, with their pitching moments zero when the angle of attack alpha is zero. As seen with the NACA 0024 airfoil 1211, as alpha moves from zero, the corresponding pitching moment (Cm) moves in the same direction, thus for positive alpha there is a positive pitching moment which tends to force the airfoil further off wind. In contrast, when using the airfoil designated T3 1210 according to some embodiments of the present invention, the pitching moment is negative as the angle of attack goes positive, until about 10 degrees alpha in this example.

The present invention has been particularly shown and described with respect to certain preferred embodiments and specific features thereof. However, it should be noted that the above-described embodiments are intended to describe the principles of the invention, not limit its scope. Therefore, as is readily apparent to those of ordinary skill in the art, various changes and modifications in form and detail may be made without departing from the spirit and scope of the invention as set forth in the appended claims. Other embodiments and variations to the depicted embodiments will be apparent to those skilled in the art and may be made without departing from the spirit and scope of the invention as defined in the following claims. Also, reference in the claims to an element in the singular is not intended to mean “one and only one” unless explicitly stated, but rather, “one or more”. Furthermore, the embodiments illustratively disclosed herein can be practiced without any element which is not specifically disclosed herein.

What is claimed is:

1. A tether system for the tethering of airborne wind energy systems, said tether system comprising:
a tether adapted to support an airborne wind energy craft; and
an aerodynamic tether sheath,
wherein said tether is adapted to reside within said aerodynamic tether sheath.

2. The tether system of claim 1 wherein said tether comprises electrical conductors.

3. The tether system of claim 1 wherein said tether sheath comprises a UV resistive outer layer.

4. The tether system of claim 1 wherein said tether sheath comprises a cloth outer layer.

5. The tether system of claim 1 wherein said aerodynamic tether sheath comprises a symmetric profile, said symmetric profile adapted to provide a negative bending moment at angles of attack less than 5 degrees.

6. The tether system of claim 1 wherein said tether comprises structural elements adapted to withstand axial tension in the tether.

7. The tether system of claim 1 wherein said tether is cylindrical.

8. The system of claim 6 wherein said tether is cylindrical.

9. An aerodynamic tether, said tether comprising a symmetric airfoil profile, wherein said profile is adapted to provide a negative bending moment at angles of attack less than 5 degrees
